(19) United States
(12) Patent Application Publication
(10) Pub. No.: US 2024/0224274 A1
(43) Pub. Date: Jul. 4, 2024

(54) SR TRIGGERING METHOD AND RANDOM ACCESS METHOD AND APPARATUSES, DEVICE AND STORAGE MEDIUM

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN); Xinlei YU, Dongguan (CN)

(73) Assignee: GUANGDONG OPPO MOBILE TELECOMMUNICATIONS CORP., LTD., Dongguan (CN)

(21) Appl. No.: 18/607,466

(22) Filed: Mar. 16, 2024

Related U.S. Application Data
(63) Continuation of application No. PCT/CN2021/118880, filed on Sep. 16, 2021.

(51) Int. Cl. H04W 72/1268; H04W 56/00; H04W 76/20; H04W 80/02

(52) U.S. Cl. CPC H04W 72/1268; H04W 56/0045; H04W 76/20; H04W 80/02

(57) ABSTRACT

A method for triggering an SR triggering and a terminal are provided. The method is applied to a terminal in a RRC connected state, and includes the following operation. An SR is triggered when a Timing Advance (TA) report is triggered and an uplink resource satisfies an unavailable condition. The uplink resource is a Physical Uplink Shared Channel (PUSCH) resource used for a new uplink transmission.

### CROSS-REFERENCE TO RELATED APPLICATIONS

This is a continuation application of International Patent Application No. PCT/CN2021/118880, filed on Sep. 16, 2021, the disclosure of which is hereby incorporated by reference in its entirety.

### BACKGROUND

In New Radio (NR) system, in order to ensure the orthogonality of uplink transmission, a network device requires that the time of signals which are sent by different terminals at the same time on different frequency domain resources reach the network device are substantially aligned. In order to ensure the time synchronization in the network device, an uplink Timing Advance (TA) mechanism is supported in the NR system. In a Non Terrestrial Network (NTN), a delay of signal transmission between a UE and a network is greatly increased. In order to deal with the large propagation delay, a timing relationship of the NTN system is enhanced compared with that of the NR system. For a timing sequence influenced by an interaction between downlink reception and uplink transmission, an offset parameter k_{offset} is introduced into the timing relationship, and a value of the offset parameter is configured by the network. The network device configures the value of the offset parameter k_{offset} through a TA value.

Since a terminal having positioning capacity may usually estimate the TA value corresponding to a service link through location information of the terminal and ephemeris information, and perform, by using the TA value, a TA pre-compensation for uplink transmission, but the network device cannot obtain the location of the terminal and the TA pre-compensation value adopted by the terminal. In related technologies, a terminal may assist the network device to configure the offset parameter k_{offset} for the terminal by reporting the TA.

However, the TA value used by the terminal in a Radio Resource Control (RRC) connected state is larger than the offset parameter k_{offset} configured by the network device in some scenarios, which causes that the terminal cannot normally perform uplink transmission based on a resource allocation instruction of the network device for the uplink transmission.

### SUMMARY

The disclosure relates to the field of mobile communication, and particularly to a method and a device for triggering a Scheduling Request (SR), so that a terminal can report a TA to a network device in time, thereby assisting the network device to configure a suitable k_{offset} for the terminal.

A first aspect of the present disclosure provides a method for triggering an SR. The method is applied to a terminal in a RRC connected state, and includes the following operation.

A SR is triggered when a Timing Advance (TA) report is triggered and an uplink resource satisfies an unavailable condition.

The uplink resource is a Physical Uplink Shared Channel (PUSCH) resource used for a new uplink transmission.

A second aspect of the present disclosure provides a terminal. The terminal includes a processor, a transceiver and a memory for storing executable instructions of the processor. The transceiver and the memory are connected to the processor. The processor is configured to load and execute the executable instructions to implement: triggering an SR when a Timing Advance (TA) report is triggered and an uplink resource satisfies an unavailable condition. The uplink resource is a Physical Uplink Shared Channel (PUSCH) resource for a new uplink transmission.

### BRIEF DESCRIPTION OF THE DRAWINGS

In order to more clearly illustrate the technical solution in the embodiments of the present disclosure, the drawings needed in the description of the embodiments will be briefly introduced below. It is apparent that the drawings described below are only some embodiments of the present disclosure, and other drawings can be obtained according to these drawings without creative effort for those of ordinary skill in the art.

FIG. 1 is a network architecture diagram of a transparent transmission payload Non Terrestrial Network (NTN) provided by an exemplary embodiment of the present disclosure;

FIG. 2 is a network architecture diagram of a regenerative payload NTN provided by an exemplary embodiment of the present disclosure;

FIG. 3 is a timing relationship of a NTN system provided by an exemplary embodiment of the present disclosure;

FIG. 4 is a timing relationship of a NTN system provided by an exemplary embodiment of the present disclosure;

FIG. 5 is a flowchart of a method for triggering an SR provided by an exemplary embodiment of the present disclosure;

FIG. 6 is a flowchart of a method for triggering an SR provided by an exemplary embodiment of the present disclosure;

FIG. 7 is a flowchart of a method for triggering an SR provided by an exemplary embodiment of the present disclosure;

FIG. 8 is a flowchart of a method for random access provided by an exemplary embodiment of the present disclosure;

FIG. 9 is a flowchart of a method for random access provided by an exemplary embodiment of the present disclosure;

FIG. 10 is a flowchart of a method for triggering an SR provided by an exemplary embodiment of the present disclosure;

FIG. 11 is a flowchart of a method for random access provided by an exemplary embodiment of the present disclosure;

FIG. 12 is a flowchart of a method for information configuration provided by an exemplary embodiment of the present disclosure;

FIG. 13 is a flowchart of a method for information configuration provided by an exemplary embodiment of the present disclosure;

FIG. 14 is a schematic structural diagram of a device for triggering an SR provided by an exemplary embodiment of the present disclosure;

FIG. 15 is a schematic structural diagram of a device for random access provided by an exemplary embodiment of the present disclosure;

FIG. 16 is a schematic structural diagram of a device for information configuration provided by an exemplary embodiment of the present disclosure;

FIG. 17 is a block diagram of a communication device illustrated by an exemplary embodiment of the present disclosure.

### DETAILED DESCRIPTION

In order to make the purpose, technical solution and advantages of the present disclosure clearer, the embodiments of the present disclosure are described in further detail below with reference to the drawings.

At present, the Third Generation Partnership Project (3GPP) is studying a NTN technology, and the NTN technology generally provides communication services to terrestrial users through a satellite communication. Compared with terrestrial cellular network communication, the satellite communication has many advantages. First of all, the satellite communication is not limited by user regions. For example, general land communications cannot cover areas such as oceans, high mountains, deserts, etc., at which communication devices cannot be set up or communication coverage cannot be done due to sparse population. For the satellite communication, because a satellite can cover a large ground and the satellite can orbit around the earth, theoretically every corner of the earth can be covered by the satellite communication. Secondly, the satellite communication has great social value. The Satellite communication can cover remote mountainous areas and poor and backward countries or regions at a lower cost, so that people in these regions can enjoy advanced voice communication and mobile Internet technologies, which can narrow the digital divide with developed regions and prompts the development of these regions. Thirdly, the satellite communication distance is long, and communication costs do not increase significantly with the increase of the communication distance. Finally, the stability of the satellite communication is high and is not limited by natural disasters.

Communication satellites are divided into Low-Earth Orbit (LEO) satellites, Medium-Earth Orbit (MEO) satellites, Geostationary Earth Orbit (GEO) satellites, High Elliptical Orbit (HEO) satellites and so on according to different orbital altitudes. At present, the LEO and the GEO are mainly studied.

### LEO

The altitude range of the LEO satellites is 500 km˜1500 km, and the orbital period is about 1.5 hours to 2 hours. The signal propagation delay of a single-hop communication between users is generally less than 20 ms. The maximum satellite visual time is 20 minutes. The signal propagation distance is short, the link loss is less, and the requirement for the transmission power of the user terminal is not high.

### GEO

The orbital altitude of the GEO satellites is 35786 km, and the rotation period of the GEO around the Earth is 24 hours. The signal propagation delay of a single-hop communication between users is generally 250 ms.

In order to ensure the coverage of the satellites and improve the system capacity of the entire satellite communication system, the satellites cover the ground with multiple beams, and one satellite may form dozens or even hundreds of beams to cover the ground. One satellite beam may cover a ground region having a diameter of tens to hundreds of kilometers.

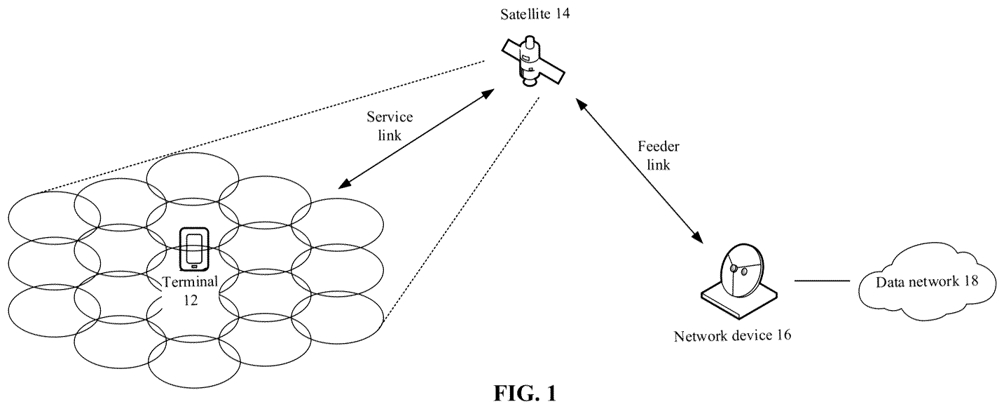

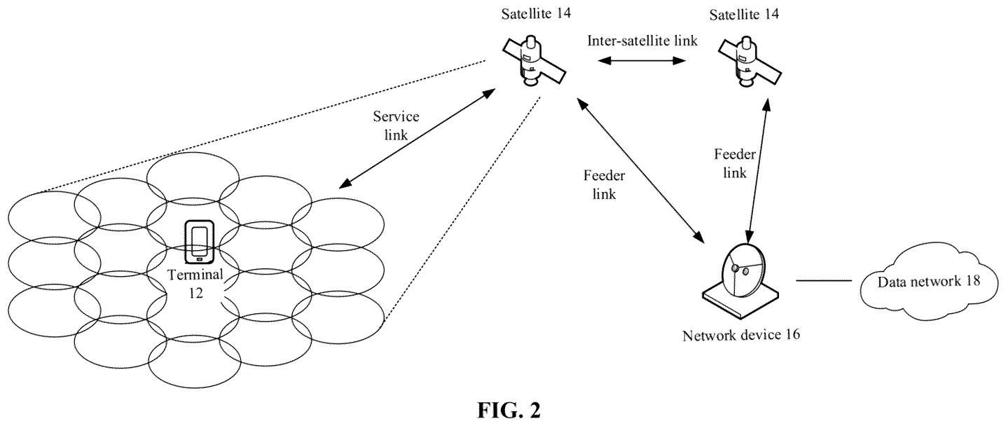

There are at least two NTN scenarios including a transparent transmission payload NTN scenario and a regenerative payload NTN scenario. FIG. 1 illustrates the transparent payload NTN scenario and FIG. 2 illustrates the regenerative payload NTN scenario.

The NTN network consists of the following network elements: one or more gateways for connecting a satellite and a terrestrial public network; a feeder link for a communication between the gateway and the satellite; a service link for a communication between a terminal and the satellite; a satellite which can be divided, according to a function provided, into the transparent payload and the regenerative payload; a transparent transmission payload which only provides functions of radio frequency filtering, frequency transforming and amplifying, and provides transparent transmission forwarding of signals, and does not change the forwarded waveform signal; regenerative payload which provides, in addition to functions of radio frequency filtering, frequency transforming and amplifying, functions of demodulating/decoding, routing/transforming, encoding/modulating, the regenerative payload has some or all functions of a network device; Inter-satellite link (ISL) which exists in the regenerative payload scenario.

Schematically, as illustrated in FIG. 1 and FIG. 2, in both scenarios of an NTN, the network device 16 may be a base station, and the base station is a device used to provide wireless communication functions for a terminal. The base station may include various forms of macro base stations, micro base stations, relay stations, access points and the like. The names of devices which functions as a base station in systems with different wireless access technologies may be different, for example, a device which functions as a base station in a LTE system is referred to as eNodeB or eNB; a device which functions as a base station in a 5G NR-U system is referred to as gNodeB or gNB. With the evolution of the communication technology, the description for “base station” may change. In the embodiments of the present disclosure, the above-mentioned device which provides wireless communication functions for the terminal 14 is collectively referred to as a network device.

A random access procedure refers to a process that the terminal sends a random access preamble to try to access the network until a basic signaling connection is established between the terminal and the network. The terminal establishes a data communication with the network side in the random access procedure. In NR, two types of random access procedures are supported, and two types of random access procedures include random access procedure of a first type and a random access procedure of a second type.

The random access procedure of the first type is a 4-step random access procedure.

The random access procedure of the first type includes the following steps.

In step 1, the terminal transmits a message 1 (msg1) to the network device, which is a random access preamble.

The terminal transmits a selected random access preamble on a time-frequency resource of a selected Physical Random Access Channel (PRACH), and the network device can estimate uplink timing and a grant size required by the terminal to transmit a message 3 based on the random access preamble.

In step 2, the network device transmits a message 2 (msg2) to the terminal, which is a Random Access Response (RAR).

After the terminal transmits the msg1, a RAR window is started, and a Physical Downlink Control Channel (PDCCH) is monitored within the RAR window. The PDCCH is a PDCCH scrambled with a Random Access Radio Network Temporary Identifier (RA-RNTI).

After the PDCCH scrambled with the RA-RNTI is successfully monitored, the terminal can obtain a Physical Downlink Share Channel (PDSCH) scheduled by the PDCCH, and the PDSCH contains the RAR.

The RAR contains: a Backoff Indicator (BI) indicating a backoff time for retransmitting msg1; a Random Access Preamble Identifier (RAPID) indicating the random access preamble; a Time Advance Group (TAG) for adjusting the uplink timing; an uplink grant (UL grant) for scheduling an uplink resource indication of the msg3; a Temporary Cell-Radio Network Temporary Identity (Temporary C-RNTI) for scrambling the PDCCH of a msg4 (Initial Access).

In step 3, the terminal transmits msg3 to the network device, which is schedule transmission.

The msg3 is used to inform an event that the network device triggers the random access procedure. Exemplarily, if the event is an initial access random procedure, a UE ID and an establishment cause are carried in the msg3. If the event is a RRC reconstruction, a UE ID in a connected state and the establishment cause are carried in the msg3.

In step 4, the network device transmits a message 4 (msg4) to the terminal which is a contention resolution message. The msg4 is used for a conflict resolution.

In step 5, the terminal transmits a message 5 (msg5) to the network device, which is connection establishment complete.

The msg5 is used to inform the network device that the connection establishment of the random access is completed.

The random access procedure of the second type is 2-step random access procedure.

In the contention-based random access procedure, the 4-step random access procedure can be combined as a 2-step random access procedure. The combined 2-step random access procedure includes a message A (msgA) and a message B (msgB), and the following steps are included.

In step 1, the terminal transmits the msgA to the network device.

In step 2, after receiving the msgA transmitted by the terminal, the network device transmits the msgB to the terminal.

Optionally, the msgA includes the contents of the msg1 and the msg3, i.e., the msgA includes: a random access preamble and a UE ID, the UE ID may be one of a C-RNTI, a temporary C-RNTI, a RA-RNTI, and a Non-Access Stratum (NAS) UE ID. Optionally, the msgB includes the contents of msg2 and msg4, i.e., the msgB includes a RAR and a contention resolution message.

The network device determines a TA value of each terminal by measuring the uplink transmission of the terminal. The network device transmits a Timing Advance Command (TAC) to the terminal through at least one of scenarios of acquiring an initialized TA and adjusting a TA of the terminal in an RRC connected state, to inform the terminal of a time amount for advancing the uplink transmission.

In the scenario of acquiring an initialized TA, the network device determines a TA value by measuring the received preamble during the random access procedure, and transmits the TA value to the terminal through a TAC field of the RAR.

In the scenario of adjusting a TA of the terminal in a RRC connected state, although the terminal and the network device have achieved uplink synchronization during the random access procedure, the timing of an uplink signal arriving at the network device may change with time. Therefore, the terminal needs to constantly update the TA to maintain the uplink synchronization. If the TA of a terminal needs to be corrected, the network device transmits a TAC to the terminal for asking the terminal to adjust the TA. The TAC is transmitted to the terminal in a Medium Access Control (MAC) Control Element (CE).

In the NTN system, the terminal needs to consider the TA when performing an uplink transmission. Because of a large propagation delay in the system, a range of a TA value is also relatively large. When a terminal is scheduled to perform uplink transmission in a slot n, the terminal performs uplink transmission in advance in consideration of a round-trip propagation delay, to assert that when a signal arrives at the network device on the uplink slot n. Specifically, a timing relationship in the NTN system may include two cases, as shown in FIG. 3 and FIG. 4 below, respectively.

In case 1, as shown in FIG. 3, like the NR terrestrial network, a downlink slot and an uplink slot of the network device are aligned with each other. Accordingly, in order to align the uplink transmission of the terminal with the uplink slot of the network device, a large TA value is required by the terminal. A large offset parameter k_{offset} is also needed when performing the uplink transmission.

In case 2, as shown in FIG. 4, there is an offset value between the downlink slot and the uplink slot of the network device. In such a case, in order to align the uplink transmission of the terminal with the uplink slot of the network device, a small TA value is required. However, in this case, an additional scheduling complexity may be required for the network device to perform the scheduling timing.

Terminals in the NTN scenario have a Global Navigation Satellite System (GNSS) positioning capability and a TA pre-compensation capability, i.e., the terminals may determine the TA corresponding to a service link based on the GNSS positioning capability and ephemeris information of a service satellite. The terminal may determine the TA based on the following formula:

$${T}_{TA} = ( {N}_{TA} + {N}_{TA , UF - Specific} + {N}_{TA , common} + {N}_{TA , offset} ) \times {T}_{C}$$

N_{TA} is updated based on the TAC transmitted by the network; N_{TA,UE-Specific} is a TA corresponding to a service link estimated by the User Equipment (UE); N_{TA,common} is a common TA broadcasted by a network, and N_{TA,offset} is a fixed offset value.

A timing relationship in the existing NR system includes a receiving timing of a Physical Downlink Shared Channel (PDSCH), and a transmission timing of a PUSCH scheduled by a DCI, a transmission timing of a PUSCH granted to be scheduled by a RAR, a transmission timing of transmitting a Hybrid Automatic Repeat request Acknowledge character (HARQ-ACK) on the PUCCH, an MAC CE activation timing, a transmission timing of Channel State Information (CSI) on the PUSCH, a CSI reference resource timing, a transmission timing of a aperiodic SRS.

Regarding the receiving timing of a Physical Downlink Shared Channel (PDSCH), when a terminal is scheduled by a Digital Copyright Identifier (DCI) to receive the PDSCH, the DCI includes indication information K0, which is used to determine a slot for transmitting the PDSCH. For example, if the scheduling DCI is received on a slot n, the slot allocated for transmitting the PDSCH is a slot

$$[ n \frac{{2}^{{μ}_{PDSCH}}}{{2}^{{μ}_{PDCCH}}} ] + K 0 ,$$

where K0 is determined according to the subcarrier spacing of the PDSCH, μ_{PDSCH} and μ_{PDCCH} are used to determine subcarrier spacing configured for the PDSCH and a Physical downlink Control Channel (PDCCH), respectively. A value of K0 ranges from 0 to 32.

As to the transmission timing of a PUSCH scheduled by a DCI, when the terminal is scheduled by the DCI to transmit the PUSCH, the DCI includes indication information K2, which is used to determine a slot for transmitting the PUSCH. For example, if the scheduling DCI is received on a slot n, the slot allocated for transmitting the PUSCH is a slot

$$[ n \frac{{2}^{{μ}_{PDSCH}}}{{2}^{{μ}_{PDCCH}}} ] + K 0 ,$$

where K2 is determined according to the subcarrier spacing of the PDSCH, μ_{PDSCH} and μ_{PDCCH} are used to determine the subcarrier spacing configured for the PUSCH and the PDCCH, respectively. A value of K2 ranges from 0 to 32.

As to the transmission timing of a PUSCH scheduled by a RAR grant. with respect to a slot scheduled by the RAR grant for transmitting a PUSCH, if the end position that the PDSCH including an RAR grant message is received by the terminal is in a slot n after the terminal initiates a Physical Random Access Channel (PRACH) transmission, the terminal transmits the PUSCH on a slot n+K2+Δ, where K2 and Δ are agreed in the protocol.

As to the transmission timing of transmitting a Hybrid Automatic Repeat request Acknowledge character (HARQ-ACK) on the PUCCH, with respect to a slot for transmitting the PUCCH, if an end position of a PDSCH reception is in a slot n or an end position of a PDCCH reception indicating release of SPS PDSCH is in a slot n, the terminal should transmit HARQ-ACK information on PUCCH resources within a slot n+K1, where K1 is the number of the slots and is indicated by an information field of the PDSCH-to-HARQ-timing-indicator in DCI format, or provided by a dl-DataToUL-ACK parameter. K1=0 indicates that a last slot of the PUCCH transmission overlaps with a slot of the PDSCH reception or the PDCCH reception for indicating the release of the SPS PDSCH.

As to the MAC CE activation timing, when HARQ-ACK information corresponding to the PDSCH including the MAC CE command is transmitted on a slot n, a behavior indicated by the MAC CE command and a downlink configuration assumed by the terminal comes into effect from a first slot subsequent to a slot n+3Nₛₗₒₜ^{subframe,μ}, where Nₛₗₒₜ^{subframe,μ} represents the number of time slots included in each subframe under the subcarrier spacing configuration μ.

As to transmission timing of Channel State Information (CSI) on the PUSCH, the transmission timing of the CSI on the PUSCH is the same as the transmission timing of the PUSCH transmission scheduled by the DCI in general.

As to the CSI reference resource timing, CSI reference resources for reporting CSI on an uplink slot n′ is determined according to a single downlink slot n-n_{CSI_ref}, where

$$n = [ {n}^{′} \frac{{2}^{{μ}_{DL}}}{{2}^{{μ}_{UL}}} ] ,$$

μ_{DL} and μ_{UL} are subcarrier spacing configurations for downlink and uplink, respectively. A value of n_{CSI_ref} depends on the type reported by the CSI.

As to the transmission timing of a aperiodic SRS, if the terminal receives DCI on a slot n for triggering transmission of the aperiodic SRS, the UE transmits the aperiodic SRS in each triggered SRS resource set on a slot

$$n {2}^{\frac{{μ}_{SRS}}{{μ}_{PDCCH}}} + k ,$$

where k is configured by a high layer parameter Slot Offset in each triggered SRS resource set and is determined according to a subcarrier spacing corresponding to the triggered SRS transmission, μ_{SRS} and μ_{PDCCH} are the triggered SRS transmission and the subcarrier spacing configuration of the PDCCH carrying the trigger command, respectively.

Timing enhancement of the NTN system is described as follows.

The PDSCH reception timing in the NR system is only influenced by the timing of the downlink reception side, and is not influenced by a large round-trip transmission delay in the NTN system. Therefore, the PDSCH reception timing in the NR system can be reused in the NTN system.

For other timing influenced by an interaction between a downlink reception and an uplink transmission, in order to work normally in the NTN system, or to overcome the large transmission delay in the NTN system, the timing relationship needs to be enhanced. A simple solution is to introduce an offset parameter k_{offset} into the system, and apply this parameter to the following timing relationship: a transmission timing of the PUSCH scheduled by the DCI (including CSI transmitted on the PUSCH), a transmission timing of the PUSCH scheduled by the RAR grant, a transmission timing of transmitting the HARQ-ACK on the PUCCH, an MAC CE activation timing, a CSI reference resource timing, a transmission timing of a aperiodic SRS.

As to the transmission timing of the PUSCH scheduled by the DCI (including CSI transmitted on the PUSCH), if the scheduled DCI is received on a slot n, the slot allocated for PUSCH transmission is a slot

$$[ n \frac{{2}^{{μ}_{PDSCH}}}{{2}^{{μ}_{PDCCH}}} ] + K 2 + {k}_{offset} .$$

As to the transmission timing of the PUSCH scheduled by the RAR grant, with respect to a slot scheduled by the RAR grant for PUSCH transmission, the terminal transmits the PUSCH in a slot n+K2+Δ+k_{offset}.

As to the transmission timing of transmitting the HARQ-ACK on the PUCCH, with respect to a slot for PUCCH transmission, the UE should transmit HARQ-ACK information on PUCCH resources within a slot n+K1+k_{offset}.

As to the MAC CE activation timing, when HARQ-ACK information corresponding to the PDSCH including the MAC CE command is transmitted on a slot n, a behavior indicated by the MAC CE command and a downlink configuration assumed by the terminal comes into effect from a first slot subsequent to a slot n+XNₛₗₒₜ^{subframe,μ}+k_{offset}, where X may be determined by a terminal capability of the NTN and a value of X may not be 3.

As to the CSI reference resource timing, CSI reference resources for reporting CSI on an uplink slot n′ is determined according to a single downlink slot n-n_{CSIref}−k_{offset}.

As to the transmission timing of a aperiodic SRS, if the terminal receives DCI on a slot n for triggering transmission of the aperiodic SRS, the UE transmits the aperiodic SRS in each triggered SRS resource set on a slot

$$n {2}^{\frac{{μ}_{SRS}}{{μ}_{PDCCH}}} + k + {k}_{offset} .$$

In the NTN system, the timing of the uplink transmission is enhanced by k_{offset}.

For an initial random access procedure, a network device may configure a cell-level k_{offset} or satellite beam-level k_{offset} in a broadcast manner

For a terminal in a connected state, the network device may configure a UE-specific k_{offset} for the terminal through a Radio Resource Control (RRC) signaling or a MAC.

If the network device does not configure a UE-specific k_{offset} the terminal uses a k_{offset} configured in the broadcast manner.

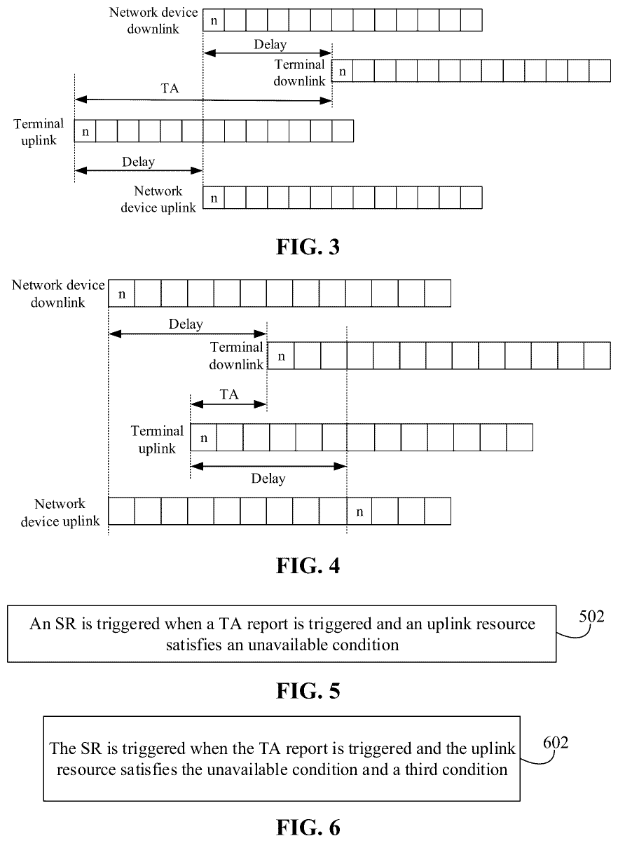

FIG. 5 illustrates a flowchart of a method for triggering an SR provided by an exemplary embodiment of the present disclosure. The method is applied to a terminal in a RRC connected state in this embodiment. Optionally, the terminal is an NTN-enabled terminal. The method includes an operation 502.

At operation 502, when a TA report is triggered, and an uplink resource satisfies an unavailable condition, a SR is triggered.

In the NTN scenario, when the terminal in the RRC connected state triggers the TA report, and the uplink resource satisfies an unavailable condition, the terminal triggers the SR, and the SR is in a pending state after the terminal triggers the SR.

The uplink resource is a PUSCH resource for a new transmission. Schematically, the PUSCH resource is used for at least one of transmitting data and an MAC CE of the TA report, which is not limited in the present disclosure.

Optionally, the TA report includes at least one of a TA report based on a periodicity; a TA report based on an event trigger; or a TA report based on a network request.

Optionally, the uplink resource satisfying the unavailable condition includes at least one of the following conditions that the uplink resource satisfies a first condition; or the uplink resource satisfies a second condition.

The first condition includes that there is no first uplink resource for a new transmission, and the second condition includes that there is a second uplink resource for a new transmission, but the second uplink resource cannot accommodate a MAC CE of the TA report.

Exemplarily, the terminal triggers a TA report, and the terminal triggers an SR when there is no PUSCH resource used for the new transmission.

Exemplarily, the terminal triggers a TA report, and the terminal triggers a SR when there is a PUSCH resource used for the new transmission, but the PUSCH resource cannot accommodate an MAC CE of the TA report.

The SR is used for requesting scheduling the uplink resource for the TA report, or the SR is used for requesting scheduling the PUSCH resource for the new transmission.

When a SR is triggered and there is a PUCCH resource available for transmitting the SR, the terminal transmits the SR to the network device. When the network device receives the SR, the network device schedules the PUSCH resource for the new transmission to the terminal, which is used by the terminal to perform the TA report.

To sum up, in the method provided by the embodiment, the terminal in the RRC connected state triggers the SR when the terminal triggers the TA report but the PUSCH resource satisfies the unavailable condition. In the embodiment, by triggering the SR and there is an available PUCCH resource, the terminal transmits the SR to the network device, and upon receiving the SR, the network device schedules the PUSCH resource for the new transmission to the terminal, and the terminal can report a TA in time, thereby avoiding the TA from being larger than a value of a offset parameter k_{offset}, and ensuring that the terminal can normally perform an uplink transmission.

FIG. 6 illustrates a flowchart of a method for triggering an SR provided by an exemplary embodiment of the present disclosure. The method is applied to a terminal in a RRC connected state in this embodiment. Optionally, the terminal is an NTN-enabled terminal. The method includes the following operation 602.

At operation 602, an SR is triggered when a TA report is triggered and uplink resource satisfies both the unavailable condition and a third condition.

When the TA report is triggered and the uplink resource satisfies both the unavailable condition and the third condition, the terminal triggers the SR. The third condition includes that a difference between k_{offset} and the TA is less than or equal to a first threshold, k_{offset} is an offset parameter for enhancing a scheduling timing relationship, and the TA is a TA currently used by the terminal.

Optionally, the first threshold is configured by the network device to the terminal through a system broadcast, or, the first threshold is configured by the network device to the terminal through a specific signaling, or, the first threshold is predefined by a communication protocol, which is not limited in the present disclosure. A value of the first threshold is larger than zero. Exemplarily, the specific signaling is a signaling which can be correctly decoded and received by only the terminal (or a terminal group).

The uplink resource is a PUSCH resource used for a new transmission. Schematically, the PUSCH resource is used for at least one of transmitting data and an MAC CE of the TA report, which is not limited in the present disclosure.

Optionally, the TA report includes at least one of a TA report based on a periodicity, a TA report based on an event trigger, or a TA report based on a network request.

Optionally, the unavailable condition satisfied by the uplink resource includes at least one of a first condition or a second condition.

The first condition includes that there is no first uplink resource for a new transmission, and the second condition includes that there is a second uplink resource for a new transmission, but the second uplink resource cannot accommodate a MAC CE of the TA report.

In a possible implementation, the terminal triggers the SR when the terminal triggers the TA report, and has no PUSCH resource used for the new transmission, and the terminal satisfies the third condition.

In a possible implementation, the terminal triggers the SR when the terminal triggers the TA report, and has a PUSCH resource for the new transmission, but the PUSCH resource cannot accommodate the MAC CE of the TA report, and the terminal satisfies the third condition.

When a SR is triggered and there is a PUCCH resource available for transmitting the SR, the terminal transmits the SR to the network device. Upon receiving the SR, the network device schedules the PUSCH resource used for the new transmission to the terminal, which is used by the terminal to perform the TA report.

To sum up, the terminal in the RRC connected state triggers the SR when the terminal triggers a TA report and the uplink transmission resource satisfies both the unavailable condition and a third condition. In the embodiment, by triggering the SR, the terminal transmits the SR to the network device, and upon receiving the SR, the network device schedules the PUSCH resource for the new transmission to the terminal, and the terminal can report a TA in time, thereby avoiding the TA from being larger than a value of a offset parameter k_{offset}, and ensuring that the terminal can normally perform an uplink transmission.

According to the contents described in FIG. 5 and FIG. 6, the terminal in the RRC connected state triggers the SR when the SR triggering condition is satisfied. FIG. 7 illustrates a flowchart of a method for triggering an SR provided by an exemplary embodiment of the present disclosure. The method includes the following operations 701 to 705.

At operation 701, the terminal receives configuration information.

In a possible implementation, the terminal receives first configuration information, the first configuration information is used for configuring a scheduling request identity (SR ID) corresponding to a TA report, and the SR ID is an ID corresponding to a SR configuration.

The network device may configure the SR configuration corresponding to the TA report for the terminal, that is, the TA report corresponds to a specific SR configuration in this configuration mode. The network device configures the SR ID corresponding to the TA report for the terminal, and the SR ID corresponds to an SR configuration.

In a possible implementation, the terminal receives second configuration information, and the second configuration information is used for configuring a SR configuration. In this manner, there is no need to explicitly configure the SR ID corresponding to the TA report, and any SR configuration (i.e., the second configuration information) can be used for SR transmission triggered by the TA report.

This operation 701 is an optional operation. The network device may configure, for the terminal, an SR configuration corresponding to the TA report or a common SR configuration, or the network device may not configure for the terminal the SR configuration corresponding to the TA report or a common SR configuration.

At operation 702, the SR is triggered when the TA report is triggered but the PUSCH resource for transmitting the TA report satisfies an unavailable condition.

Exemplarily, the terminal in the RRC connected state triggers the SR when the terminal triggers the TA report but the PUSCH resource used for transmitting the TA report satisfies an unavailable condition.

Exemplarily, the terminal in the RRC connected state triggers the SR when the terminal triggers the TA report and the uplink resource satisfies both the unavailable condition and the third condition.

After the terminal triggers the SR, the SR is in a pending state.

At operation 703, when the SR is in the pending state, the SR is cancelled in case that a cancellation condition is satisfied.

When the SR is in the pending state, the terminal cancels the SR in case that the cancellation condition is satisfied.

In a possible implementation, the SR is cancelled when the SR is in the pending state and the terminal satisfies the cancellation condition.

Optionally, the cancellation condition for cancelling the SR includes at least one of the following conditions.

The terminal cancels the SR in a condition that the terminal completes the TA report, i.e., the terminal transmits a Medium Access Control Protocol Data Unit (MAC PDU), and the MAC PDU includes an MAC CE of the TA report. Alternatively, the terminal cancels the SR in a condition that the terminal receives a reconfiguration signaling for reconfiguring k_{offset}. Alternatively, the terminal cancels the SR in a condition that the terminal receives a reconfiguration signaling for reconfiguring k_{offset}, and a difference between the reconfigured k_{offset} and the TA is greater than or equal to a second threshold.

Optionally, the second threshold is configured by the network device to the terminal through a system broadcast, or, the second threshold is configured by the network device to the terminal through a specific signaling, or, the second threshold is predefined by a communication protocol, which is not limited in the present disclosure. A value of the second threshold is larger than or equal to zero.

At operation 704, when the SR is in the pending state, a random access procedure is triggered in case that a trigger condition is satisfied.

When the SR is in the pending state, the terminal triggers the random access procedure in case that the trigger condition is satisfied. After the random access procedure is triggered, the terminal can use a common k_{offset} broadcasted by the network, or the network device can enable the terminal to complete the TA report through the random access procedure.

In a possible implementation, when the SR is in a pending state, the random access process is triggered in case that the terminal satisfies the trigger condition.

Optionally, when the SR is in the pending state, the random access procedure is triggered in case that the terminal satisfies the trigger condition, the trigger condition includes at least one of the following conditions: a condition that there is no PUCCH resource for transmitting the SR in the terminal, and a condition that the number of transmitting the SR exceeds a maximum SR transmission number.

As to the condition that there is no PUCCH resource for transmitting the SR in the terminal, in a possible implementation, at operation 701, the terminal receives first configuration information, the first configuration information is used for configuring a SR ID corresponding to the TA report, and the SR ID is an ID corresponding to a SR configuration. The PUCCH resource for transmitting the SR is determined based on the SR configuration corresponding to the SR ID of the TA report, and the SR is transmitted through the PUCCH resource. In case that the SR ID corresponding to the TA report is not configured, it is determined that there is no PUCCH resource for transmitting the SR.

The network device may configure the SR ID corresponding to the TA report for the terminal, that is, the TA report corresponds to the specific SR configuration in this configuration manner. The network device configures the SR ID corresponding to the TA report for the terminal, and the SR ID corresponds to a SR configuration. In case that the network device configures the SR ID corresponding to the TA report for the terminal, the PUCCH resource in the SR configuration corresponding to the SR ID is determined as the PUCCH resource for transmitting the SR, and the terminal transmits the SR through the PUCCH resource.

In case that the network device does not configure, for the terminal, the SR ID corresponding to the TA report, it is determined that there is no PUCCH resource for transmitting the SR. When the TA report of the terminal triggers the SR, the random access procedure is triggered, and the random access procedure is triggered in case that there is no PUCCH resource for transmitting the SR.

In a possible implementation, at operation 701, the terminal receives second configuration information, and the second configuration information is used for configuring a SR configuration. The PUCCH resource for transmitting the SR is determined based on the SR configuration, and the SR is transmitted through the PUCCH resource. In case that the SR configuration is not configured, it is determined that there is no PUCCH resource for transmitting the SR.

The network device configures the SR configuration for the terminal. In the configuration manner, in case that the TA report of the terminal triggers the SR, the PUCCH resource for transmitting the SR is determined based on the SR configuration, and the terminal transmits the SR through the PUCCH resource.

In case that the SR configuration is not configured, and when the TA report of the terminal triggers the SR, it is determined that there is no PUCCH resource for transmitting the SR, and the random access procedure is triggered. The random access procedure is triggered in case that there is no uplink resource for transmitting the SR. Any SR configuration can be used as the SR triggered by the TA report.

As to the condition that the number of transmitting the SR exceeds a maximum SR transmission number, in a possible implementation, the number of transmitting the SR corresponding to the SR has reached the maximum SR transmission number, the terminal triggers the random access procedure. In the embodiment, the maximum SR transmission number may be a default value or configured by a network, which is not limited in the embodiment.

At operation 705, before the random access procedure is ended, the random access procedure is stopped in case that a stopping condition is satisfied.

In a possible implementation, the random access procedure which is triggered by the terminal in case that there is no PUCCH resource for transmitting the SR is stopped when the stopping condition is satisfied.

Optionally, the stopping condition which is satisfied by the terminal to stop the random access procedure includes at least one of the following conditions.

In a condition that the terminal receives an uplink scheduling grant and transmits the TA report using an uplink resource scheduled by the uplink scheduling grant, and the terminal stops the random access procedure.

Exemplarily, the terminal receives an uplink scheduling grant and the uplink scheduling grant is not indicated in a message 2 or a message B, the terminal transmits a MAC PDU using the uplink scheduling grant and the MAC PDU includes a MAC CE of the TA report. In this case, the terminal stops the random access procedure. Alternatively, upon receiving a reconfiguration signaling for reconfiguring k_{offset}, the terminal stops the random access procedure. Alternatively, when the terminal receives a reconfiguration signaling for reconfiguring k_{offset}, and a difference between k_{offset} and the TA is greater than or equal to a third threshold, the terminal stops the random access procedure.

Optionally, the third threshold is configured by the network device to the terminal through a system broadcast, or, the third threshold is configured by the network device to the terminal through a specific signaling, or, the third threshold is predefined by a communication protocol, which is not limited in the present disclosure. A value of the third threshold is larger than or equal to zero.

To sum up, the terminal in the RRC connected state triggers the SR when the terminal triggers the TA report and there is no PUSCH resource for a new transmission, or when the terminal triggers the TA report and there is a PUSCH resource for the new transmission, but the PUSCH resource cannot accommodate a MAC CE of the TA report; or when the terminal triggers the TA report and there is no PUSCH resource used for the new transmission, and the difference between k_{offset} and the TA is less than or equal to the first threshold; or when the terminal triggers the TA report and there is a PUSCH resource used for the new transmission, but the PUSCH resource cannot accommodate the MAC CE of the TA report, and the difference between the k_{offset} and the TA is less than or equal to the first threshold, and the terminal request the PUSCH resource for the new transmission from the network device by transmitting the SR to the network device, which is used by the terminal to perform the TA report.

The terminal cancels the SR, when the SR is in the pending state and in case that the terminal completes the TA report, or in case that the terminal receives the reconfiguration signaling for reconfiguring k_{offset}, or in case that the terminal receives the reconfiguration signaling for reconfiguring k_{offset} and the difference between the reconfigured k_{offset} and the TA is greater than or equal to a second threshold.

The terminal triggers the random access procedure when the SR is in a pending state, in case that there is no PUCCH resource for transmitting the SR, or in case that the number of transmitting an SR corresponding to the SR has reached the maximum SR transmission number.

The random access procedure is stopped, in case that the terminal receives the uplink scheduling grant and transmits the TA report using the uplink resource scheduled by the uplink scheduling grant, or the terminal receives the reconfiguration signaling for reconfiguring k_{offset}, or the terminal receives the reconfiguration signaling for reconfiguring k_{offset}, and a difference between k_{offset} and the TA is greater than or equal to the third threshold.

In the embodiment, by triggering the SR, the SR is transmitted to the network device using the PUCCH resource in the terminal, and upon receiving the SR, the network device schedules the PUSCH resource for the new transmission to the terminal, so that the terminal can report the TA in time, thereby ensuring that the terminal can normally perform an uplink transmission.

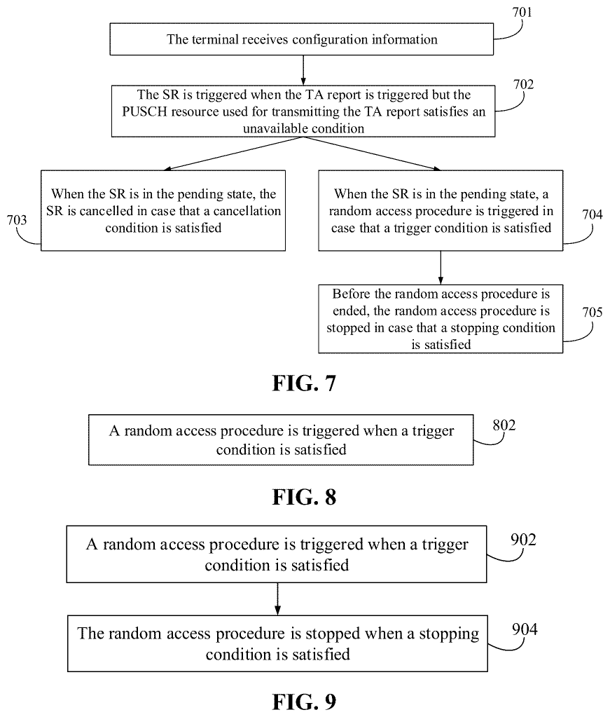

FIG. 8 illustrates a flowchart of a method for random access provided by an exemplary embodiment of the present disclosure. The method is applied to a terminal in a RRC connected state in the embodiment. Optionally, the terminal is an NTN-enabled terminal. The method includes the following operation 802.

At operation 802, a random access procedure is triggered when a trigger condition is satisfied.

In the NTN scenario, the terminal in the RRC connected state triggers the random access procedure when the trigger condition is satisfied.

The trigger condition includes at least one of the following conditions:
a TA of the terminal exceeds k_{offset},
a difference between k_{offset} and the TA is less than or equal to a fourth threshold.

In a possible implementation, the terminal receives k_{offset} configured by the network device. The terminal compares a currently used k_{offset} with a currently used TA value. In case that the TA value currently used by the terminal is less than or equal to k_{offset} currently used by the terminal, the terminal can normally perform the uplink transmission according to a resource allocation instruction for the uplink transmission.

In case that the TA value currently used by the terminal is larger than or equal to k_{offset} currently used by the terminal, i.e., in case that TA>k_{offset} or TA=k_{offset}, the terminal triggers a random access procedure.

The terminal transmits a message 3 in the random access procedure using a common k_{offset}.

The common k_{offset} is a cell-level common k_{offset} or a beam-level common k_{offset} broadcasted by a network. Before the terminal receives a specific k_{offset} configured for the terminal by the network device, the terminal always use the common k_{offset}, i.e., the terminal always uses the cell-level common k_{offset} or the beam-level common k_{offset} for broadcasted by the network.

In a possible implementation, the terminal compares a currently used k_{offset} with a currently used TA value, and the terminal triggers the random access procedure in case that a difference between the TA value currently used by the terminal and the k_{offset} currently used by the terminal is less than or equal to a fourth threshold.

Optionally, the fourth threshold is configured by the network device to the terminal through a system broadcast, or, the fourth threshold is configured by the network device to the terminal through a specific signaling, or, the fourth threshold is predefined by a communication protocol, which is not limited in the present disclosure. A value of the fourth threshold is larger than or equal to zero.

To sun up, the terminal in the RRC connected state triggers the random access procedure in case that the trigger condition is satisfied. By triggering the random access procedure, the terminal uses an effective and available k_{offset} in the embodiment, so as to ensure that the terminal can normally perform the uplink transmission.

FIG. 9 illustrates a flowchart of a method for random access provided by an exemplary embodiment of the present disclosure. The method is applied to a terminal in a RRC connected state in this embodiment. Optionally, the terminal is an NTN-enabled terminal. The method includes the following operations 902 and 904.

At operation 902, a random access procedure is triggered when a trigger condition is satisfied.

In the NTN scenario, the terminal in the RRC connected state triggers the random access procedure in a case that the trigger condition is satisfied.

The trigger condition includes: a condition that a TA of the terminal exceeds k_{offset}, or a condition that a difference between k_{offset} and the TA is less than or equal to a fourth threshold.

In a possible implementation, the terminal receives k_{offset} configured by the network device. The terminal compares a currently used k_{offset} with a currently used TA value, and the terminal can normally perform uplink transmission according to a resource allocation instruction for the uplink transmission in a case that the TA value currently used by the terminal is less than or equal to the k_{offset} currently used by the terminal.

In case that the TA value currently used by the terminal is larger than or equal to the k_{offset} currently used by the terminal, i.e., in case that TA>k_{offset} or TA=k_{offset}, the terminal triggers the random access procedure.

In a possible implementation, the terminal compares a currently used k_{offset} with a currently used TA value, and the terminal triggers the random access procedure in case that the difference between the TA value currently used by the terminal and the k_{offset} currently used by the terminal is less than or equal to the fourth threshold.

At operation 904, the random access procedure is stopped when a stopping condition is satisfied.

In a possible implementation, before the random access procedure is ended, the terminal stops the random access procedure when the stopping condition is satisfied.

Optionally, the stopping condition which is satisfied by the terminal to stop the random access procedure includes at least one of the following condition that the terminal receives an uplink scheduling grant and transmits the TA report using an uplink resource scheduled by the uplink scheduling grant.

Exemplarily, the terminal receives an uplink scheduling grant and the uplink scheduling grant is not indicated in a message 2 or a message B, the terminal transmits a MAC PDU using the uplink scheduling grant and the MAC PDU includes a MAC CE of the TA report. In this case, the terminal stops the random access procedure. Alternatively, upon receiving a reconfiguration signaling for reconfiguring k_{offset}, the terminal stops the random access procedure. Alternatively, when the terminal receives a reconfiguration signaling for reconfiguring k_{offset}, and a difference between k_{offset} and the TA is greater than or equal to a fifth threshold, the terminal stops the random access procedure.

Optionally, the fifth threshold is configured by the network device to the terminal through a system broadcast, or, the fifth threshold is configured by the network device to the terminal through a specific signaling, or, the fifth threshold is predefined by a communication protocol, which is not limited in the present disclosure. A value of the fifth threshold is larger than or equal to zero.

To sum up, the terminal in the RRC connected state triggers the random access procedure in case that the trigger condition is satisfied. Before the random access procedure is ended, the terminal stops the random access procedure in case that the stopping condition is satisfied. By triggering the random access procedure, the terminal use the effective k_{offset}, by triggering the random access procedure, thereby avoiding the TA from being larger than a value of k_{offset}, and ensuring that the terminal can normally perform an uplink transmission.

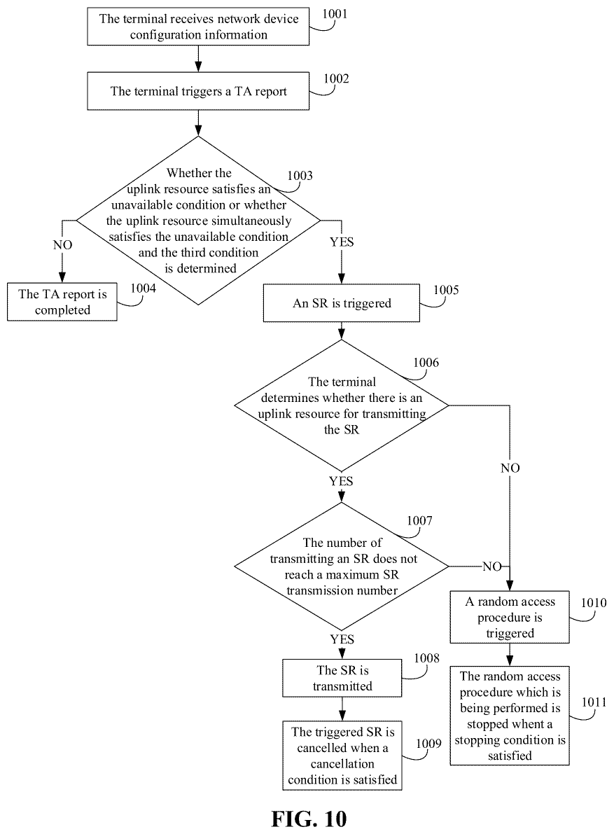

FIG. 10 illustrates a flowchart of a method for triggering SR provided by an exemplary embodiment of the present disclosure. The method is applied to a terminal in a RRC connected state in the embodiment. Optionally, the terminal is an NTN-enabled terminal. The method includes the following operations 1001 to 1011.

At operation 1001, the terminal receives configuration information transmitted by a network device.

At operation 1002, the terminal triggers a TA report.

The terminal receives network device configuration information, and the terminal triggers a TA report based on the network device configuration information. The TA report includes at least one of a TA report based on a periodicity; a TA report based on an event trigger; or a TA report based on a network request.

At operation 1003, whether the uplink resource satisfies an unavailable condition or whether the uplink resource satisfies the third condition when the uplink resource satisfies the unavailable condition is determined.

After the terminal triggers the TA report, an operation 1004 is performed in case that the uplink resource satisfies an available condition. After the terminal triggers the TA report, an operation 1005 is performed when the uplink resource satisfies the unavailable condition and the third condition. The third condition includes that a difference between k_{offset} and the TA is less than or equal to a first threshold, k_{offset} is an offset parameter for enhancing a scheduling timing relationship, and the TA is a TA currently used by the terminal.

At operation 1004, the TA report is completed.

The terminal triggers the TA report, and the TA report is completed in case that the uplink resource satisfies the available condition.

At operation 1005, a SR is triggered.

In case that the terminal triggers the TA report and the PUSCH resource satisfies the unavailable condition and the third condition, the terminal triggers the SR.

At operation 1006, the terminal determines whether there is an uplink resource for transmitting the SR.

Whether there is an uplink resource for transmitting the SR in the terminal is determined, and the uplink resource for transmitting the SR is a PUCCH resource for transmitting the SR. In case that there is a PUCCH resource for transmitting the SR in the terminal, an operation 1007 is performed. In case that there is no PUCCH resource for transmitting the SR in the terminal, an operation 1010 is performed.

At operation 1007, the number of transmitting the SR does not reach a maximum SR transmission number.

When there is a PUCCH resource for transmitting the SR in the terminal, whether the number of transmitting the SR has not reached a maximum SR transmission number is determined, and an operation 1010 is performed when the number of transmitting the SR reaches the maximum SR transmission number. An operation 1008 is performed when the number of transmitting the SR does not reach the maximum SR transmission number.

At operation 1008, the SR is transmitted.

The terminal transmits the SR when there is a PUCCH resource for transmitting the SR in the terminal and the number of transmitting the SR does not reach the maximum SR transmission number.

At operation 1009, the triggered SR is cancelled when a cancellation condition is satisfied.

After the terminal transmits the SR, the terminal cancels the triggered SR when the cancellation condition is satisfied.

The cancellation condition for cancelling the triggered SR includes at least one of the following conditions.

The terminal cancels the SR after the terminal completes the TA report in a condition that the terminal completes the TA report, i.e., the terminal transmits a Medium Access Control Protocol Data Unit (MAC PDU), and the MAC PDU includes an MAC CE of the TA report. Alternatively, the terminal cancels the SR in a condition that the terminal receives a reconfiguration signaling for reconfiguring k_{offset}. Alternatively, the terminal cancels the SR in a condition that the terminal receives a reconfiguration signaling for reconfiguring k_{offset}, and a difference between the reconfigured k_{offset} and the TA is greater than or equal to a second threshold.

At operation 1010, a random access procedure is triggered.

The terminal triggers the random access procedure in case that there is no PUCCH resource for transmitting the SR in the terminal, or in case that the number of transmitting the SR reaches the maximum SR transmission number.

At operation 1011, the random access procedure which is being performed is stopped when a stopping condition is satisfied.

Before the random access procedure is ended, the terminal stops the random access procedure when the stopping condition is satisfied.

Optionally, the random access is triggered in response to there being no effective PUCCH resource for transmitting the SR in the terminal.

The stopping condition satisfied which is satisfied by the terminal to stop the random access procedure includes at least one of the following conditions.

In a condition that the terminal receives an uplink scheduling grant and transmits the TA report using an uplink resource scheduled by the uplink scheduling grant, and the terminal stops the random access procedure.

Exemplarily, the terminal receives an uplink scheduling grant and the uplink scheduling grant is not indicated in a message 2 or a message B, the terminal transmits a MAC PDU using the uplink scheduling grant and the MAC PDU includes a MAC CE of the TA report. In this case, the terminal stops the random access procedure. Alternatively, upon receiving a reconfiguration signaling for reconfiguring k_{offset}, the terminal stops the random access procedure. Alternatively, when the terminal receives a reconfiguration signaling for reconfiguring k_{offset}, and a difference between k_{offset} and the TA is greater than or equal to a third threshold, the terminal stops the random access procedure.

Optionally, the third threshold is configured by the network device to the terminal through a system broadcast, or the third threshold is configured by the network device to the terminal through a specific signaling, or the third threshold is predefined by a communication protocol, which is not limited in the present disclosure. A value of the third threshold is larger than or equal to zero.

It should be noted that the second threshold and the third threshold may be a same configuration parameter, which is not limited in the embodiment of the present disclosure.

To sum up, the terminal in the RRC connected state receives network device configuration information, and the terminal triggers the SR in case that the TA report is triggered and the PUSCH resource for the new transmission satisfies the unavailable condition. In case that there is no PUCCH resource for transmitting the SR in the terminal, or in case that the number of transmitting the SR reaches the maximum SR transmission number, the terminal triggers the random access procedure. The terminal stops the random access procedure when the stopping condition is satisfied. In the embodiment, the terminal reports a TA in time by transmitting the SR, thereby ensuring that the terminal can normally perform an uplink transmission.

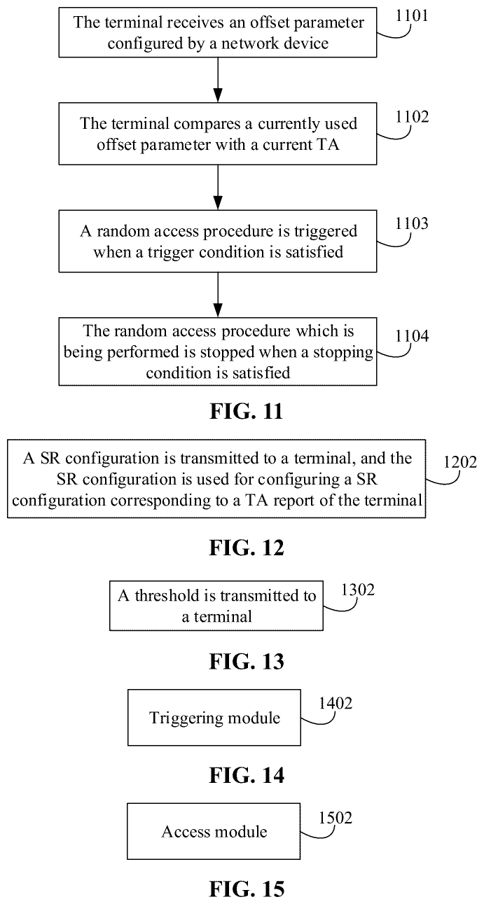

FIG. 11 illustrates a flowchart of a method for random access provided by an exemplary embodiment of the present disclosure. The method is applied to a terminal in a RRC connected state in this embodiment. Optionally, the terminal is an NTN-enabled terminal. The method includes the following operations 1101 to 1104.

At operation 1101, the terminal receives an offset parameter configured by a network device.

The terminal receives k_{offset} configured by a network device.

At operation 1102, the terminal compares a currently used k_{offset} with a currently used TA value.

The terminal compares a currently used k_{offset} with a currently used TA value, the terminal can normally perform uplink transmission according to a resource allocation instruction for the uplink transmission in case that the TA value currently used by the terminal is less than or equal to the k_{offset} currently used by the terminal.

At operation 1103, a random access procedure is triggered when a trigger condition is satisfied.

The trigger condition includes: a condition that a TA of the terminal exceeds k_{offset}, or a difference between k_{offset} and the TA is less than or equal to a fourth threshold

The terminal compares a currently used k_{offset} with a currently used TA value, and the terminal triggers the random access procedure in case that the TA value currently used by the terminal is larger than or equal to the k_{offset} currently used by the terminal, i.e., in case of TA>k_{offset} or TA=k_{offset}.

The terminal compares a currently used k_{offset} with a currently used TA value, the terminal triggers the random access procedure in case that the difference between the TA value currently used by the terminal and the k_{offset} currently used by the terminal is less than or equal to the fourth threshold.

Optionally, the fourth threshold is configured by the network device to the terminal through a system broadcast, or the fourth threshold is configured by the network device to the terminal through a specific signaling, or the fourth threshold is predefined by a communication protocol, which is not limited in the present disclosure. A value of the fourth threshold is larger than or equal to zero.

At operation 1104, the random access procedure which is being performed is stopped in case that a stopping condition is satisfied.

Before the random access procedure is ended, the terminal stops the random access procedure which is being performed, in case that the stopping condition is satisfied.

The stopping condition which is satisfied by the terminal to stop the random access procedure includes at least one of the following condition that the terminal receives an uplink scheduling grant and transmits the TA report using an uplink resource scheduled by the uplink scheduling grant.

Exemplarily, the terminal receives an uplink scheduling grant and the uplink scheduling grant is not indicated in a message 2 or a message B, the terminal transmits a MAC PDU using the uplink scheduling grant and the MAC PDU includes a MAC CE of the TA report. In this case, the terminal stops the random access procedure. Alternatively, upon receiving a reconfiguration signaling for reconfiguring k_{offset}, the terminal stops the random access procedure. Alternatively, when the terminal receives a reconfiguration signaling for reconfiguring k_{offset}, and a difference between k_{offset} and the TA is greater than or equal to a fifth threshold, the terminal stops the random access procedure.

It should be noted that the third threshold and the fifth threshold may be a same configuration parameter, which is not limited in the embodiment of the present disclosure.

To sum up, the terminal in the RRC connected state compares a currently used k_{offset} with a currently used TA value, the random access procedure is triggered in case that the trigger condition is satisfied. Before the random access procedure is ended, the terminal stops the random access procedure in case that the stopping condition is satisfied. By triggering the random access procedure, the terminal uses an effective and available k_{offset} in the embodiment, so as to ensure that the terminal can normally perform the uplink transmission.

FIG. 12 illustrates a flowchart of a method for information configuration provided by an exemplary embodiment of the present disclosure. The method is applied to a network device in this embodiment. Optionally, the network device is an NTN-enabled network device. The method includes the following operation 1202.

At operation 1202, an SR configuration is transmitted to a terminal, and the SR configuration is used for configuring an SR configuration corresponding to a TA report of the terminal.

In the NTN scenario, the network device transmits the SR configuration to the terminal, and the SR configuration is used for configuring the SR configuration corresponding to the TA report of the terminal.

Optionally, the network device transmits first configuration information to the terminal, and the first configuration information is used for configuring a SR ID corresponding to the TA report, and the SR ID is an ID corresponding to the SR configuration.

The network device configures a SR configuration corresponding to the TA report to the terminal, that is, the TA report corresponds to a specific SR configuration in this configuration manner. The network device configures the SR ID corresponding to the TA report for the terminal, and the SR ID corresponds to an SR configuration.

Optionally, the network device transmits second configuration information to the terminal, and the second configuration information is used for configuring a SR configuration. In this manner, there is no need to explicitly configure the SR ID corresponding to the TA report, and any SR configuration can be used for SR transmission triggered by the TA report.

It can be understood by combining with the method embodiments of the terminal side, that the network device transmits the SR configuration to the terminal, and the SR configuration is used for configuring the SR configuration corresponding to the TA report of the terminal. The network device transmits the SR configuration to the terminal, and in case that the network device transmits the first configuration information to the terminal, the PUCCH resource for transmitting the SR is determined based on the SR configuration corresponding to the SR ID of the TA report, and the SR is transmitted through the PUCCH resource. In case that the network device transmits the second configuration information to the terminal, the PUCCH resource for transmitting the SR is determined based on the SR configuration, and the SR is transmitted through the PUCCH resource. By transmitting the SR, the terminal reports a TA in time in the embodiment, thereby ensuring that the terminal can normally perform an uplink transmission.

FIG. 13 illustrates a flowchart of a method for information configuration provided by an exemplary embodiment of the present disclosure. The method is applied to a network device in this embodiment. Optionally, the network device is an NTN-enabled network device. The method includes the following operation 1302.

At operation 1302, a threshold is transmitted to a terminal.

In a possible implementation, the network device configures a first threshold to the terminal.

Optionally, the network device configures the first threshold to the terminal through a system broadcast, or the network device configures the first threshold to the terminal through a specific signaling.

The first threshold is a difference threshold between a TA and an offset parameter k_{offset} for triggering the SR in case that the uplink resource satisfies the unavailable condition after the TA report is triggered. The first threshold is used for triggering the SR, the k_{offset} is an offset parameter for enhancing a scheduling timing relationship, and the TA is a TA currently used by the terminal. The terminal triggers the SR, in case that the TA report is triggered, the uplink resource satisfies the unavailable condition and the difference between the k_{offset} and the TA is less than or equal to the first threshold, which is not limited in the embodiment of the present disclosure, and a value of the first threshold is larger than zero.

In a possible implementation, the network device configures a second threshold to the terminal.

Optionally, the network device configures the second threshold to the terminal through a system broadcast, or the network device configures the second threshold to the terminal through a specific signaling.

The second threshold is a difference threshold between an offset parameter k_{offset} and a TA, the second threshold is used for cancelling a SR, the k_{offset} is an offset parameter for enhancing a scheduling timing relationship, and the TA is a TA currently used by the terminal. The terminal cancels the SR in case that the terminal receives the reconfiguration signaling for reconfiguring the offset parameter k_{offset} and the difference between the offset parameter k_{offset} and the TA is greater than or equal to the second threshold.

In a possible implementation, the network device configures a third threshold to the terminal.

Optionally, the network device configures the third threshold to the terminal through a system broadcast, or the network device configures the third threshold to the terminal through a specific signaling.

The third threshold is a difference threshold between an offset parameter k_{offset} and a TA, the third threshold is used for stopping a first random access procedure, the first random access procedure is triggered in response to a SR in a pending state satisfying a trigger condition, the k_{offset} is an offset parameter for enhancing a scheduling timing relationship, and the TA is a TA currently used by the terminal. The terminal stops the first random access procedure in case that the terminal receives the reconfiguration signaling for reconfiguring the offset parameter k_{offset} and the difference between the offset parameter k_{offset} and the TA is greater than or equal to the third threshold.

In a possible implementation, the network device configures a fourth threshold to the terminal.

Optionally, the network device configures the fourth threshold to the terminal through a system broadcast, or the network device configures the fourth threshold to the terminal through a specific signaling.

The fourth threshold is a difference threshold between an offset parameter k_{offset} and a TA, the fourth threshold is used for triggering a second random access procedure, the k_{offset} is an offset parameter for enhancing a scheduling timing relationship, and the TA is a TA currently used by the terminal. The terminal triggers the second random access procedure in case that the TA exceeds k_{offset}, or a difference between the k_{offset} and the TA is less than or equal to the fourth threshold.

In a possible implementation, the network device configures a fifth threshold to the terminal.

Optionally, the network device configures the fifth threshold to the terminal through a system broadcast, or the network device configures the fifth threshold to the terminal through a specific signaling.

The fifth threshold is a difference threshold between an offset parameter k_{offset} and a TA, the fifth threshold is used for stopping a second random access procedure, the k_{offset} is an offset parameter for enhancing a scheduling timing relationship, and the TA is a TA currently used by the terminal. The terminal stops the second random access procedure in case that the TA exceeds k_{offset}, or a difference between the k_{offset} and the TA is greater than or equal to the fifth threshold.

It should be noted that the second threshold and the third threshold may be a same configuration parameter, the third threshold and the fifth threshold may be a same configuration parameter, which is not limited in the embodiment of the present disclosure. In case that the second threshold and the third threshold are the same configuration parameter, the second threshold value and the third threshold value in the present embodiment may be configured in the same configuration process. Similarly, in case that the third threshold and the fifth threshold are the same configuration parameter, the third threshold and the fifth threshold in the present embodiment may be configured in the same configuration process.

To sum up, the network device configures the first threshold to the terminal through a system broadcast or a specific signaling, and the terminal triggers the SR in case that the TA report is triggered, and when the uplink resource satisfies the unavailable condition and the difference between the offset parameter k_{offset} and the TA is less than or equal to the first threshold. The network device configures the second threshold to the terminal through a system broadcast or a specific signaling, and the terminal cancels the SR in case that the terminal receives the reconfiguration signaling for reconfiguring the offset parameter k_{offset} and the difference between the offset parameter k_{offset} and the TA is greater than or equal to the second threshold. The network device configures the third threshold to the terminal through a system broadcast or a specific signaling, and the terminal stops the first random access procedure in case that the terminal receives the reconfiguration signaling for reconfiguring the offset parameter k_{offset} and the difference between the offset parameter k_{offset} and the TA is greater than or equal to the third threshold. The network device configures the fourth threshold to the terminal through a system broadcast or a specific signaling, and the terminal triggers the second random access procedure in case that the TA exceeds k_{offset} or a difference between the k_{offset} and the TA is less than or equal to the fourth threshold. The network device configures the fifth threshold to the terminal through a system broadcast or a specific signaling, and the terminal stops the second random access procedure in case that the TA exceeds k_{offset}, or a difference between the k_{offset} and the TA is greater than or equal to the fifth threshold.

As shown schematically in FIG. 14, an embodiment of the present disclosure provides a device for triggering SR, and the device may be embodied as a whole or a part of a terminal. Alternatively, the device may be applied to the terminal. The terminal may be an NTN-enabled terminal. The device includes a triggering module 1402.

The triggering module 1402 is configured to trigger a SR when a TA report is triggered and an uplink resource satisfies an unavailable condition. The uplink resource is a PUSCH resource for a new uplink transmission.

In a possible implementation, the TA report includes at least one of a TA report based on a periodicity; a TA report based on an event trigger; or a TA report based on a network request.

In a possible implementation, the unavailable condition satisfied by the uplink resource includes at least one of a first condition or a second condition.

The first condition includes that there is no first uplink resource for a new transmission, and the second condition includes that there is a second uplink resource for a new transmission, but the second uplink resource cannot accommodate a MAC CE of the TA report.

In a possible implementation, the triggering module 1402 is further configured to trigger the SR when the TA report is triggered and the uplink resource satisfies the unavailable condition and a third condition.

The third condition includes that a difference between k_{offset} and the TA is less than or equal to a first threshold, k_{offset} is an offset parameter for enhancing a scheduling timing relationship, and the TA is a TA currently used by the terminal.

In a possible implementation, the first threshold is configured by the network device to the terminal through a system broadcast, or the first threshold is configured by the network device to the terminal through a specific signaling, or, the first threshold is predefined by a communication protocol.

In a possible implementation, when the SR is in the pending state, the triggering module 1402 is configured to cancel the SR in case that the cancellation condition is satisfied.

In a possible implementation, the cancellation condition includes at least one of the following conditions: a condition that the terminal completes the TA report; or a condition that the terminal receives a reconfiguration signaling for reconfiguring k_{offset}; or a condition that the terminal receives a reconfiguration signaling for reconfiguring k_{offset}, and a difference between k_{offset} and the TA is greater than or equal to a second threshold.

In a possible implementation, the second threshold is configured by a network device to the terminal through a system broadcast, or the second threshold is configured by a network device to the terminal through a specific signaling, or the second threshold is predefined by a communication protocol.

In a possible implementation, when the SR is in a pending state, the triggering module 1402 is further configured to trigger a random access procedure in case that a trigger condition is satisfied.

In a possible implementation, the trigger condition includes a condition that there is no PUCCH resource for transmitting the SR, or a condition that the number of transmitting the SR exceeds a maximum SR transmission number.

In a possible implementation, the triggering module 1402 is further configured to receive first configuration information, and the first configuration information is used for configuring a SR ID corresponding to the TA report, and the SR ID is an ID corresponding to a SR configuration.

In a possible implementation, the triggering module 1402 is further configured to determine a PUCCH resource for transmitting the SR based on the SR configuration corresponding to the SR ID for the TA report.

The SR is transmitted through the PUCCH resource.

In a possible implementation, the triggering module 1402 is further configured to determine that there is no PUCCH resource for transmitting the SR in case that the SR ID for the TA report is not configured.

In a possible implementation, the triggering module 1402 is further configured to receive second configuration information, and the second configuration information is used for configuring a SR configuration.

In a possible implementation, the triggering module 1402 is further configured to determine a PUCCH resource for transmitting the SR based on the SR configuration.

The SR is transmitted through the PUCCH resource.

In a possible implementation, the trigger module 1402 is further configured to determine that there is no PUCCH resource for transmitting the SR in case that no SR configuration is configured.

In a possible implementation, before a random access procedure is ended, the triggering module 1402 is further configured to stop the random access procedure in case that a stopping condition is satisfied.

In a possible implementation, the random access procedure is triggered in case that there is no PUCCH resource for transmitting the SR.

In a possible implementation, the stopping condition includes a condition that an uplink scheduling grant is received and the TA report is transmitted using an uplink resource scheduled by the uplink scheduling grant; or a condition that a reconfiguration signaling for reconfiguring k_{offset} is received; or a condition that a difference between k_{offset} and the TA is greater than or equal to a third threshold.

In a possible implementation, the condition that the uplink scheduling grant is received, and the TA report is transmitted by using the uplink resource scheduled by the uplink scheduling grant includes a condition that an uplink scheduling grant is received, and the uplink scheduling grant is not indicated in a message 2 or a message B, the terminal transmits a MAC PDU using the uplink scheduling grant, and the MAC PDU includes a MAC CE of the TA report.

In a possible implementation, the third threshold is configured by a network device to the terminal through a system broadcast; or the third threshold is configured by a network device to the terminal through a specific signaling; or the third threshold is predefined by a communication protocol.

In a possible implementation, the device is applied to a NTN scenario.

As shown schematically in FIG. 15, an embodiment of the present disclosure provides a device for random access, and the device may be realized as a whole or a part of a terminal. Alternatively, the device may be applied to the terminal. The terminal may be an NTN-enabled terminal. The device includes an access module 1502.

The access module 1502 is configured to trigger a random access procedure when a trigger condition is satisfied.

The trigger condition includes a condition that a TA of the terminal exceeds an offset parameter k_{offset}, or a condition that a difference between k_{offset} and the TA is less than or equal to a fourth threshold.

In a possible implementation, the random access procedure is triggered by transmitting a message 3 in the random access procedure using a common k_{offset}.

The common k_{offset} is a cell-level common k_{offset} or a beam-level common k_{offset} broadcasted by a network.

In a possible implementation, the fourth threshold is configured by a network device to the terminal through a system broadcast, or the fourth threshold is configured by a network device to the terminal through a specific signaling, or the fourth threshold is predefined by a communication protocol.

In a possible implementation, before the random access procedure is ended, the access module 1502 is further configured to stop the random access procedure when a stopping condition is satisfied.

In a possible implementation, the stopping condition includes a condition that an uplink scheduling grant is received and the TA report is transmitted using an uplink resource scheduled by the uplink scheduling grant; or a condition that a reconfiguration signaling for reconfiguring k_{offset} is received; or a condition that a difference between k_{offset} and the TA is greater than or equal to a third threshold.

In a possible implementation, the condition that an uplink scheduling grant is received and the TA report is transmitted using an uplink resource scheduled by the uplink scheduling grant includes a condition that an uplink scheduling grant is received, and the uplink scheduling grant is not indicated in a message 2 or a message B, the terminal transmits a MAC PDU using the uplink scheduling grant, and the MAC PDU includes a MAC CE of the TA report.

In a possible implementation, the device is applied to a NTN scenario.

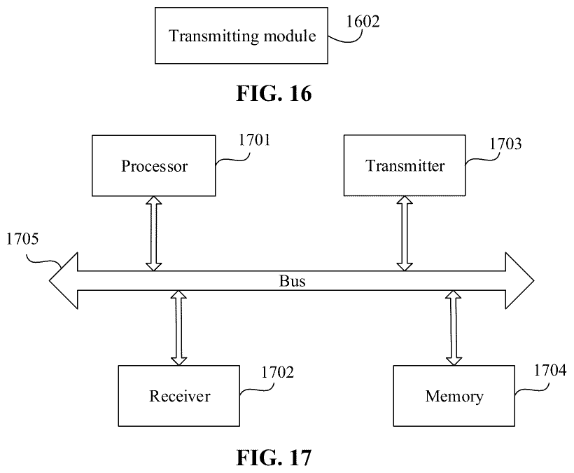

As shown schematically in FIG. 16, an embodiment of the present disclosure provides a device for information configuration, and the device may be realized as a whole or a part of a network device. Alternatively, the device may be applied to the network device. The network device may be an NTN-enabled network device. The device includes a transmitting module 1602.

The transmitting module is configured to transmit a SR configuration to a terminal, and the SR configuration is used for configuring a SR configuration corresponding to a TA report of the terminal.

In a possible implementation, the transmitting module 1602 is further configured to configure first configuration information, and the first configuration information is used for configuring a SR ID corresponding to the TA report, and the SR ID is an ID corresponding to the SR configuration.

In a possible implementation, the transmitting module 1602 is further configured to transmit first configuration information, and the first configuration information is used for configuring a SR ID corresponding to the TA report, and the SR ID is an ID corresponding to the SR configuration.

In a possible implementation, the transmitting module 1602 is further configured to configure a first threshold to the terminal through a system broadcast, or configure the first threshold to the terminal through a specific signaling.

The first threshold is a difference threshold for triggering a SR between an offset parameter k_{offset} and a TA, the first threshold is used for triggering the SR, the k_{offset} is an offset parameter for enhancing a scheduling timing relationship, and the TA is a TA currently used by the terminal.

In a possible implementation, the transmitting module 1602 is further configured to configure a second threshold to the terminal through a system broadcast, or configure the second threshold to the terminal through a specific signaling.

The second threshold is a difference threshold between an offset parameter k_{offset} and a TA, the second threshold is used for cancelling a SR, the k_{offset} is an offset parameter for enhancing a scheduling timing relationship, and the TA is a TA currently used by the terminal.

In a possible implementation, the transmitting module 1602 is further configured to configure a third threshold to the terminal through a system broadcast, or configure the third threshold to the terminal through a specific signaling.

The third threshold is a difference threshold between an offset parameter k_{offset} and a TA, the third threshold is used for stopping a first random access procedure, the first random access procedure is triggered in response to a SR in a pending state satisfying a trigger condition, the k_{offset} is an offset parameter for enhancing a scheduling timing relationship, and the TA is a TA currently used by the terminal.

In a possible implementation, the transmitting module 1602 is further configured to configure a fourth threshold to the terminal through a system broadcast, or configure the fourth threshold to the terminal through a specific signaling.

The fourth threshold is a difference threshold between an offset parameter k_{offset} and a TA, the fourth threshold is used for triggering a second random access procedure, the k_{offset} is an offset parameter for enhancing a scheduling timing relationship, and the TA is a TA currently used by the terminal.

In a possible implementation, the transmitting module 1602 is further configured to configure a fifth threshold to the terminal through a system broadcast, or configure the fifth threshold to the terminal through a specific signaling.

The fifth threshold is a difference threshold between an offset parameter k_{offset} and a TA, the fifth threshold is used for stopping a second random access procedure, the k_{offset} is an offset parameter for enhancing a scheduling timing relationship, and the TA is a TA currently used by the terminal.

FIG. 17 illustrates a schematic structural diagram of a communication device (a terminal or a network device) provided by an exemplary embodiment of the present disclosure, the communication device includes a processor 1701, a receiver 1702, a transmitter 1703, a memory 1704 and a bus 1705.

The processor 1701 includes one or more processing cores and executes various function applications and information processing by running software programs and modules.

The receiver 1702 and the transmitter 1703 may be implemented as a communication component, and the communication component may be a communication chip.

The memory 1704 is connected to the processor 1701 through the bus 1705.

The memory 1704 may be used to store at least one instruction, and the processor 1701 is used to execute the at least one instruction to implement each operation of the method for reporting the TA and the method for receiving the TA in the NTN mentioned in the above method embodiments.

In addition, the memory 1704 may be implemented by any type of a volatile storage device or a non-volatile storage device or a combination thereof, the volatile storage device or the non-volatile storage device includes but is not limited to: a magnetic disk or an optical disk, an electrically Erasable Programmable Read Only Memory (EEPROM), an Erasable Programmable Read Only Memory (EPROM), a Static Random Access Memory (SRAM), a Read-Only Memory (ROM), a magnetic memory, a flash memory, a Programmable Read-Only Memory (PROM).

An aspect of the present disclosure provides a terminal, the terminal includes a processor, a memory for storing executable instructions of the processor and a transceiver coupled to the processor. The processor is configured to load and execute the executable instructions to implement the method for triggering SR as described above, or the method for random access as described above.

An aspect of the present disclosure provides a network device, the network device includes a processor, a memory for storing executable instructions of the processor, and a transceiver coupled to the processor. The processor is configured to load and execute the executable instructions to implement the method for triggering SR as described above, or the method for random access as described above, or the method for information configuration as described above.

An aspect of the present disclosure provides a chip. The chip includes a programmable logic circuit or program, and the chip is used for implementing the method for triggering SR as described above, or the method for random access as described above, or the method for information configuration as described above.

An exemplary embodiment of the present disclosure further provides a computer-readable storage medium. The computer-readable storage medium stores executable instructions, and the executable instructions are loaded and executed by a processor to implement the method for triggering SR as described above, or the method for random access as described above, or the method for information configuration as described above.

A person of ordinary skill in the art will understand that all or a part of the operations in the above embodiments may be implemented by a hardware or may be completed by indicating a related hardware through a program, and the program may be stored in a computer-readable storage medium, the computer-readable storage medium mentioned above may be a Read-Only Memory, a magnetic disk or an optical disk, etc.

The foregoing is only the optional embodiments of the present disclosure, but is not intended to limit the present disclosure. Any modifications, equivalent replacements, improvements, etc. made within the spirit and principle of the present disclosure shall fall within the scope of protection of the present disclosure.

1. A method for triggering a Scheduling Request (SR), wherein the method is applied to a terminal in a Radio Resource Control (RRC) connected state, and comprises:
triggering an SR when a Timing Advance (TA) report is triggered and an uplink resource satisfies an unavailable condition,
wherein the uplink resource is a Physical Uplink Shared Channel (PUSCH) resource for a new uplink transmission.

2. The method of claim 1, wherein the TA report comprises at least one of:
a TA report based on a periodicity;
a TA report based on an event trigger; or
a TA report based on a network request.

3. The method of claim 1, wherein the unavailable condition satisfied by the uplink resource comprises a first condition or a second condition,
wherein the first condition comprises that there is no first uplink resource for a new transmission, the second condition comprises that there is a second uplink resource for a new transmission and the second uplink resource is unable to accommodate a Medium Access Control (MAC) Control Element (CE) of the TA report.

4. The method of claim 1, further comprising: when the SR is in a pending state,
cancelling the SR when a cancellation condition is satisfied.

5. The method of claim 4, wherein the cancellation condition comprises that:
the TA report is completed; or
a reconfiguration signaling for reconfiguring an offset parameter k_{offset} is received; or
a reconfiguration signaling for reconfiguring the offset parameter k_{offset} is received, and a difference between the offset parameter k_{offset} and a TA is greater than or equal to a second threshold.

6. The method of claim 1, further comprising: when the SR is in a pending state triggering a random access procedure when a trigger condition is satisfied.

7. The method of claim 6, wherein the trigger condition comprises that:
there is no Physical Uplink Control Channel (PUCCH) resource for transmitting the SR; or
a number of transmitting the SR corresponding to the SR has reached a maximum SR transmission number.

8. The method of claim 7, further comprising:
receiving second configuration information, wherein the second configuration information is used for configuring a SR configuration.

9. The method of claim 8, further comprising:
determining a PUCCH resource for transmitting the SR based on the SR configuration; and
transmitting the SR through the PUCCH resource.

10. The method of claim 8, further comprising:
determining that there is no PUCCH resource for transmitting the SR when no SR configuration is configured.

11. The method of claim 10, further comprising, before a random access procedure is ended, stopping the random access procedure when a stopping condition is satisfied.

12. The method of claim 11, wherein the random access procedure is triggered when there is no PUCCH resource for transmitting the SR.

13. The method of claim 11, wherein the stopping condition comprises that:
an uplink scheduling grant is received, and the TA report is transmitted by using an uplink resource scheduled by the uplink scheduling grant; or
a reconfiguration signaling for reconfiguring an offset parameter k_{offset} is received; or
a reconfiguration signaling for reconfiguring the offset parameter k_{offset} is received, and a difference between the offset parameter k_{offset} and a TA is greater than or equal to a third threshold.

14. The method of claim 13, wherein the stopping condition that the uplink scheduling grant is received and the TA report is transmitted by using the uplink resource scheduled by the uplink scheduling grant comprises:
an uplink scheduling grant is received, and the uplink scheduling grant is not indicated in a message 2 or a message B, the terminal transmits a Medium Access Control Protocol Data Unit (MAC PDU) using the uplink scheduling grant, and the MAC PDU comprises a medium access control control element (MAC CE) of the TA report.

15. The method of claim 1, wherein the method is applied to a Non Terrestrial Network (NTN) scenario.

16. A terminal, comprising:
a processor;
a transceiver; and
a memory which is configured for storing executable instructions of the processor and is coupled to the processor,
wherein the processor is configured to load and execute the executable instructions to:
trigger an SR when a Timing Advance (TA) report is triggered and an uplink resource satisfies an unavailable condition,
wherein the uplink resource is a Physical Uplink Shared Channel (PUSCH) resource for a new uplink transmission.

17. The terminal of claim 16, wherein the TA report comprises at least one of:
a TA report based on a periodicity;
a TA report based on an event trigger; or
a TA report based on a network request.

18. The terminal of claim 16, wherein the unavailable condition satisfied by the uplink resource comprises a first condition or a second condition,
wherein the first condition comprises that there is no first uplink resource for a new transmission, the second condition comprises that there is a second uplink resource for a new transmission and the second uplink resource is unable to accommodate a Medium Access Control (MAC) Control Element (CE) of the TA report.

19. The terminal of claim 16, wherein the processor is configured to load and execute the executable instructions to: when the SR is in a pending state,
cancel the SR when a cancellation condition is satisfied.

20. The terminal of claim 19, wherein the cancellation condition comprises that:
the TA report is completed; or
a reconfiguration signaling for reconfiguring an offset parameter k_{offset} is received; or
a reconfiguration signaling for reconfiguring the offset parameter k_{offset} is received, and a difference between the offset parameter k_{offset} and a TA is greater than or equal to a second threshold.
